(19) United States
(12) Patent Application Publication
(10) Pub. No.: US 2009/0311475 A1
(43) Pub. Date: Dec. 17, 2009

(54) COMPOSITE MATERIAL, PROCESS FOR ITS PRODUCTION AND ITS USE AS PACKAGING MATERIAL

(75) Inventors: Martin Kornfeld, Klosterneuburg (AT); Alfred Wegenberger, Langenlois (AT); Lambert Nekula, Hofstatten (AT); Adolf Schedl, Obergrafendorf (AT)

Correspondence Address: YOUNG & THOMPSON, 209 Madison Street, Suite 500, Alexandria, VA, 22314, US

(73) Assignee: TEICH AKTIENGESELLSCHAFT, Weinburg (AT)

(21) Appl. No.: 12/307,975

(22) PCT Filed: Jul. 5, 2007
(86) PCT No.: PCT/AT07/00337

§ 371 Date: Feb. 5, 2009

(30) Foreign Application Priority Data
Jul. 13, 2006 (AT) A 1196/2006

(51) Int. Cl. B32B 3/10; B32B 27/00; B29C 65/00; B32B 38/04; B32B 37/00

(52) U.S. Cl. 428/138; 428/335; 428/172; 156/60; 156/244.11; 156/252

(57) ABSTRACT

A composite material (1) includes a carrier layer (2) and a sealing layer (3), the carrier layer being detachably connected to the sealing layer. According to the invention, a zone (5) of separation is formed between the carrier layer and the sealing layer, whereby at least the surface region (2′) of the carrier layer (2) that borders the sealing layer (3) includes non-polar substances and at least the surface region (3′) of the sealing layer (3) that borders the carrier layer (2) includes polar substances or at least the surface region (2′) of the carrier layer (2) that borders the sealing layer (3) includes polar substances and at least the surface region (3′) of the sealing layer (3) that borders the carrier layer (2) includes non-polar substances.

The invention relates to a composite material comprising a carrier layer and a sealing layer, the carrier layer being detachably connected to the sealing layer. The invention likewise relates to a process for producing the composite material according to the invention. Furthermore, the invention relates to the use of the composite material according to the invention as packaging material.

Composite materials of the initially mentioned type are suited for a series of applications, especially for sealing packages such as food containers. Conventionally, food containers such as yogurt cups are sealed with monofoils, so-called cover plates. In this connection, the cover plate is bonded on the container edge by means of a sealing layer. During opening, it is necessary to overcome the sealing forces between the cover plate and the container edge so that the cover plate can be removed altogether from the container. This opening mechanism proceeds without difficulty in relatively solid packaged material; conversely liquid packaged material, such as whey beverages, is easily spilled. There has therefore been a transition to making available dual-layer cover plates that comprise a carrier layer and a sealing layer. If these two layers are separated from one another, openings can be formed that facilitate removal of the packaged material. In any case, in this form of packaging, a compromise must be found, on the one hand, between the detachability (peelability) of the layers from one another and, on the other hand, the detachability (peelability) of the sealing layer from the container edge.

Therefore, the object of this invention is to make available a composite material comprising a carrier layer and a sealing layer, the carrier layer being detachably connected to the sealing layer, but the sealing layer in spite of the detachment and the force applied in doing so continuing to adhere to the container edge.

According to the invention, a composite material of the initially mentioned type is proposed that is characterized in that to form a zone of separation between the carrier layer and the sealing layer, at least the surface region of the carrier layer that borders the sealing layer comprises non-polar substances and at least the surface region of the sealing layer that borders the carrier layer comprises polar substances or that at least the surface region of the carrier layer that borders the sealing layer comprises polar substances and at least the surface region of the sealing layer that borders the carrier layer comprises non-polar substances. This choice of substances according to the invention results in that based on the differing polarity, there is limited compatibility between the substances of the carrier layer, on the one hand, and the sealing layer, on the other hand. This yields a composite that can be detached in turn by applying force, for example when peeling the carrier layer off the sealing layer. The layers are detached from one another within a zone of separation so that when applying force, a clear separation between the carrier layer, on the one hand, and the sealing layer, on the other hand, takes place without the materials used being destroyed or the sealing layer being prematurely detached from the container edge.

Other embodiments of the composite material according to the invention are disclosed according to the subclaims. Thus, the carrier layer preferably has an outer layer that consists of a layer of adhesive and a separating layer. In this embodiment, the separating layer comprises polar or non-polar substances.

One process variant according to the invention for producing the composite according to the invention consists in that the sealing layer is applied to a carrier layer by lamination, lacquering or extrusion.

Another possible process variant consists in that the carrier layer is formed as a precomposite consisting of the carrier material and an outer layer, the outer layer being formed from a layer of adhesive and a separating layer. Then, the sealing layer is applied to the outer layer by lamination, lacquering, or extrusion. Here, on the sealing layer, predetermined breaking points can be produced by punching in, surface punching, sealing pressure or laser.

The predetermined breaking points, however, can also be produced on the finished product when the composite material according to the invention is sealed onto the container by means of sealing tools. By applying elevated pressure and elevated temperature with controlled selection of the substances used in the sealing layer, it is possible for them to be cut through in the region of the sealing jaws of the sealing tool in a controlled manner, so that when the carrier layer is peeled off from the sealing layer, a defined removal opening is formed that is dictated by the dimensions of the sealing tool.

Other advantageous embodiments of the process according to the invention are disclosed according to the subclaims.

The invention furthermore relates to the use of the composite material according to the invention as packaging material, especially for sealing containers. In this case, the composite material is bonded to a container by way of the sealing layer. The carrier layer is facing the consumer and can optionally have a tear-off aid, such as tabs. By means of this tear-off aid, the consumer can now separate (peel) the carrier layer from the sealing layer so that the two layers are separated from one another cleanly in terms of material within the zone of separation. The applied forces tear the sealing layer along the predetermined breaking points so that an opening for removing the packaged material is formed.

Furthermore, the composite material according to the invention can likewise be used as wrap packaging, for example for chocolate. In this use, predetermined breaking points can be present in the form of edge tearing strips in the sealing region of the chocolate package so that here a facilitated opening for the consumer is also ensured.

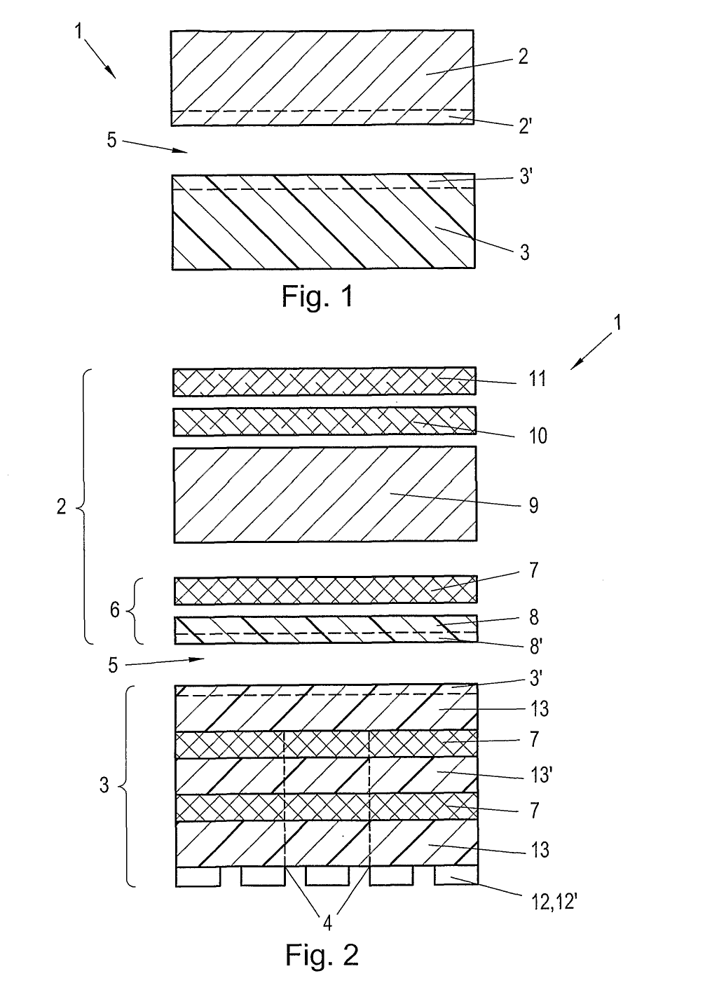

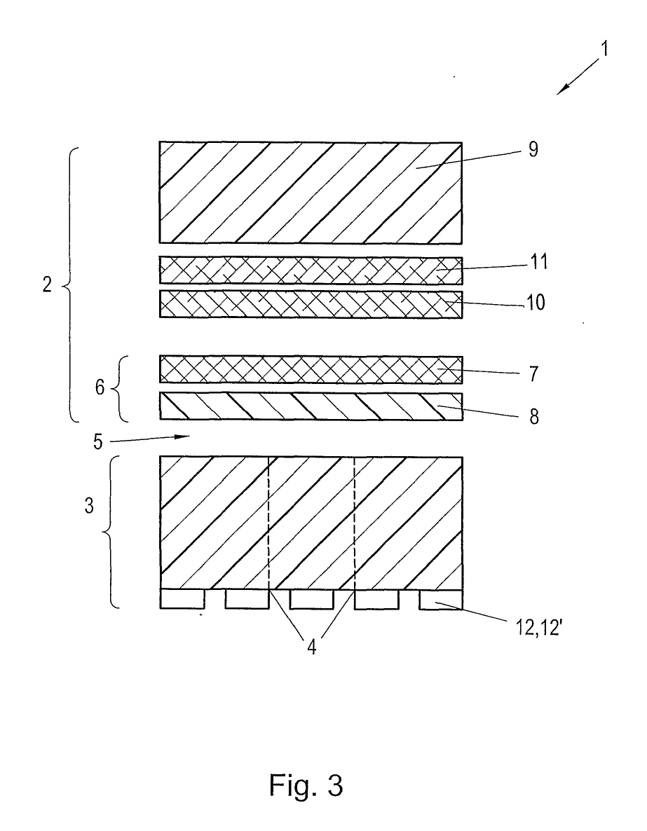

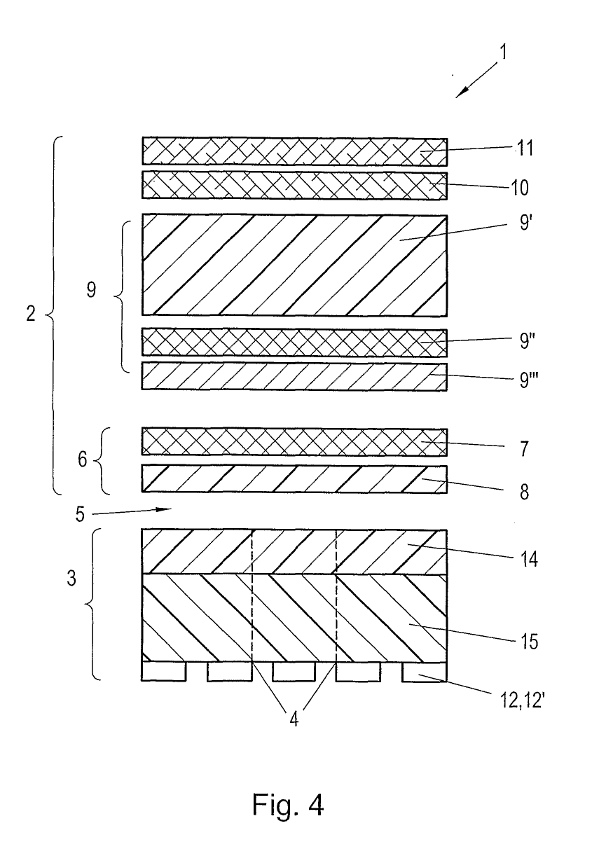

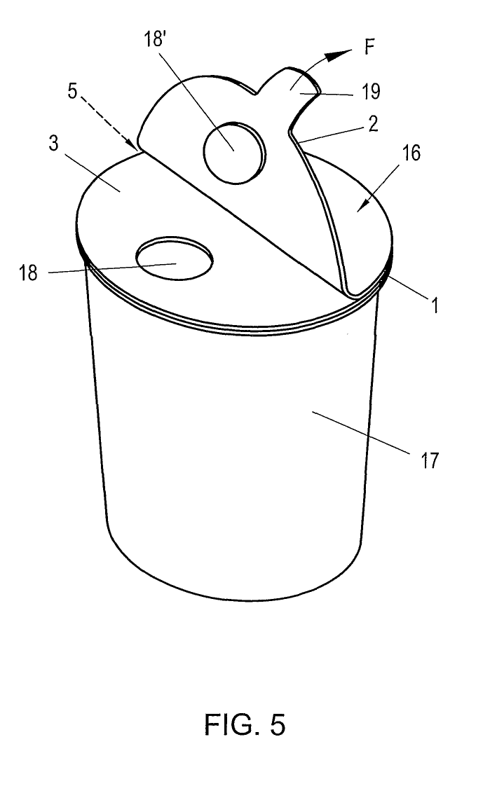

The invention is presented in more detail below based on possible embodiments for implementation of the invention. These possible embodiments are shown in FIGS. 1 to 5, FIG. 1 showing the composite material according to the invention consisting of a carrier layer and sealing layer, FIGS. 2 to 4 conversely showing possible composite structures for the carrier layer and the sealing layer, and FIG. 5 showing one possible use of the composite material according to the invention.

### EMBODIMENT 1

According to embodiment 1, which is explained in more detail based on FIG. 1, the carrier layer 2 consists of a monomaterial, for example aluminum with a thickness of roughly 40 microns. In this embodiment, the carrier layer in its surface region 2′ therefore has a polar nature, since aluminum oxide is present there. The aluminum oxide is concentrated by corresponding pretreatment of the aluminum foil, such as, for example, by preheating and/or corona treatment.

According to this embodiment, the sealing layer 3 has a non-polar nature. For this purpose, non-polar polymers, such as polyethylene or polypropylene, are used. Based on the differing polarity in surface regions 2′ and the sealing layer 3, the compatibility of the substances is limited such that a zone 5 of separation is formed by applying a force. Of course, it is also conceivable to adjust the non-polar properties by corresponding modification or pretreatment only in the surface region 3′. In any case, it is decisive that the polar and non-polar properties are present at least on the surface 2′ or 3′ so that the zone 5 of separation can be formed.

### EMBODIMENT 2

Embodiment 2 is explained in more detail based on FIG. 2, whereby for formation of the carrier layer 2, an aluminum foil that is provided on the outside with a printing primer lacquer 10 is chosen as the carrier material 9. This printing primer lacquer is used as an adhesive between the printing lacquer 11 and the carrier material 9. The printing lacquer 11 can be applied by conventional methods, such as, for example offset printing, and is used to provide the consumer with information about the type and contents of the packaged material. To form the outer layer 6, an adhesive 7 is now applied to the unprinted side of the carrier material 9, for example by lacquering, on which a separation layer 8 of styrene butadiene is applied, likewise by lacquering. The polar properties are produced by alignment or concentration of individual molecular groups or by adding additives mainly in the surface region 8′ so that a zone 5 of separation is formed. Regardless of this, the outer layer 6 should protect the carrier material 9 of aluminum against possible corrosion. The non-polar properties of the sealing layer 3 are produced in the region 3′ in which according to this example, modified polypropylene is present as a composite layer 13. The composite layer 13, by way of an adhesive layer, borders the barrier layer 13′, for example polyamide, which by way of another adhesive layer 7 borders a second composite layer 13 of modified polypropylene. Since, in the storage of composite materials, a conventionally smooth sealing layer makes further handling, such as, for example, unrolling or unstacking, difficult due to the so-called glass pane effect, the sealing layer 3 is conventionally provided with spacers 12, for example in the form of an imprint.

Instead of the spacers 12, the sealing layer can also be heated and superficially embossed so that embossing bridges 12′ are formed that can correspond in shape and dimension to the spacers 12. By enclosing air between the embossing bridges 12′, the unstacking of the composite material is greatly facilitated.

In order to facilitate partial removal of packaged material, superficial punching provides predetermined breaking points 4.

### EMBODIMENT 3

Embodiment 3 is explained in more detail based on FIG. 3. For producing the composite material according to the invention as shown in FIG. 3, a polyester, specifically polyethylene terephthalate, in a layer thickness of 7-50 microns, according to the example 36 microns, is used as the carrier material 9 to form the carrier layer 2. This carrier material is provided on its inside, i.e., essentially on the side facing the sealing layer 3, with a printing primer lacquer 10 and a laminating lacquer 11 so that the carrier layer 2 is formed. In this case, a lacquer system can be used as the separating layer 8 that, due to its polar nature, in turn causes the interaction that is desired according to the invention with the, for example, non-polar sealing layer 3 for forming the zone 5 of separation. For this purpose, the outer layer 6 consisting of the separating layer 8 and an adhesive layer 7 is formed. The non-polar sealing layer 3 consists of polypropylene and again advantageously has spacers 12 or embossing bridges 12′ in order to facilitate unstacking. The illustrated predetermined breaking points 4 can be made as a cover element when using the composite material, whereby as a result of the special sealing tools when the composite material is sealed onto the cup, material displacement within the polypropylene layer takes place so that the predetermined breaking points 4 are formed.

### EMBODIMENT 4

According to embodiment 4, to form the carrier layer 2, a composite is used as the carrier material 9 and consists of a polyethylene terephthalate film 9′, a laminating cement 9″ and a paper layer 9′″. On a side that lies to the outside, the polyethylene terephthalate layer 9′ is provided with a printing primer lacquer 10 on which an informal imprint is applied using the printing lacquer 11. The paper layer 9′″ is provided with an adhesive 7 on which the non-polar separating layer 8, for example a polyethylene coating, is applied, the outer layer 6 being formed. According to this embodiment, the sealing layer 3 consists of a composite, specifically a layer 14 of modified polyethylene copolymer and a layer 15 of unmodified polyethylene copolymer. Here, the polar properties of the sealing layer are produced by the modified polyethylene copolymer used in the layer 14, whereby spacers 12 or embossing bridges 12′ are attached to the layer 15.

Regardless of the aforementioned embodiments, it is furthermore possible to adjust the polar properties of the sealing layer 3 and the carrier layer 2 by adding additives. These additives are mainly low molecular compounds that have a non-polar end and a polar end. If such an additive, e.g., oleic acid amide or erucic acid amide, is mixed with a non-polar polyethylene, the non-polar additive remains anchored in the polyethylene; conversely, the polar end due to its incompatibility with polyethylene becomes attached to the surface to an increased degree and thus reduces adhesion. The addition of antiblocking agents, such as, e.g., silicic acid, also influences the compatibility between the respective plastics in the sealing layer 3 and the carrier layer 2.

Furthermore, it is possible to adjust the polar properties of the carrier layer 2 and the sealing layer 3 by surface modification, such as flame treatment or corona treatment. In both processes, by adding energy, oxidation processes that, for example, cause better adhesion are triggered on the plastic surface.

Likewise, it is possible to process plastics such as polyethylene at temperatures above 300° C. When the melt film emerges from the extrusion nozzle, oxidation occurs at high temperatures based on the reaction with atmospheric oxygen that can be sufficient so that polyethylene adheres to the aluminum without adhesive. In such a case, the aluminum surface has a polar oxide layer (see embodiment 1 in this respect) to which the oxidized polyethylene binds or links.

For further use of the composite material 1 according to the invention, it is now possible to produce on the sealing layer 3 by means of lasers the predetermined breaking points 4 that are present as material separations in the sealing layer in the form of holes.

Then, the composite material 1 according to the invention, as shown in FIG. 5, can be used as a cover plate 16 for sealing containers 17. In this connection, after filling the container 17 with the packaged material, such as, for example, yogurt, the cover plate 16 is bonded to the container edge by hot sealing. For this sealing process, it must be ensured that the layer bonded to the container, specifically the sealing layer 3, yields a strong, nondetachable connection. At the same time, however, in the region of the zone 5 of separation, the carrier layer 2 should be able to be pulled off the sealing layer 3. This takes place in that the consumer grasps the cover plate 16 in the region of the tab 19 and by applying force pulls it off in the direction of the arrow F. Since the composite material 1 according to the invention already is provided in its production with predetermined breaking points 4 as described in the embodiments, a removal opening 18 can now be made, produced by the applied forces. The detached region 18′ that corresponds to the removal opening 18 conversely continues to adhere to the carrier layer 2. Thus, in the region of the predetermined breaking points 4, which can also be produced by lasers, a removal opening 18 can be formed that makes it easier for the user to be able to remove the packaged material in its entirety or even only partially.

In this case, the material choice of polar or non-polar substances according to the invention must be made so that the carrier layer is removed from the sealing layer, but the sealing layer continues to adhere to the edge of the cup.

In summary, it can be stated that the composite material according to the invention, based on the specific choice of polar or non-polar substances, consists of two layers that are separated from one another in terms of material and that during production and also in use constitute a strong material composite, but this material composite can be easily detached when forces are applied, so-called peeling forces, by which the carrier layer is removed from another layer, either the sealing layer or a separating layer. When there is a separating layer that assumes one of the functions as a non-polar or polar layer material, it is additionally ensured that the predetermined breaking points in the sealing layer are protected by a continuous layer so that the carrier material, for example aluminum, is protected against corrosion.

1. Composite material 1 comprising a carrier layer 2 and a sealing layer 3, the carrier layer 2 being detachably connected to the sealing layer 3, characterized in that to form a zone 5 of separation between the carrier layer 2 and the sealing layer 3, at least the surface region 2′ of the carrier layer 2 that borders the sealing layer 3 comprises non-polar substances and at least the surface region 3′ of the sealing layer 3 that borders the carrier layer 2 comprises polar substances or that at least the surface region 2′ of the carrier layer 2 that borders the sealing layer 3 comprises polar substances and at least the surface region 3′ of the sealing layer 3 that borders the carrier layer 2 comprises non-polar substances.

2. Composite material according to claim 1, wherein the carrier material 9 for forming the carrier layer 2 is present as a monomaterial with a layer thickness of 7-150 microns, preferably 20-70 microns.

3. Composite material according to claim 1, wherein the carrier material 9 for forming the carrier layer 2 is present as a composite with a layer thickness of 20-150 microns, preferably 50-70 microns.

4. Composite material according to claim 1, wherein the carrier layer 9 is printed on one and/or both sides.

5. Composite material according to claim 1, wherein the sealing layer 3 is present as a monomaterial with a layer thickness of 15-150 microns, preferably 30-70 microns.

6. Composite material according to claim 1, wherein the sealing layer 3 is present as a composite with a total thickness of 20-250 microns, preferably 30-70 microns.

7. Composite material according to claim 1, wherein the sealing layer 3 has additives, such as dyes and/or fillers.

8. Composite material according to claim 1, wherein the sealing layer 3 has predetermined breaking points 4 in the form of surface punches, through punches or holes.

9. Composite material according to claim 1, wherein the sealing layer 3 on its outside has spacers 12 with rough surfaces.

10. Composite material according to claim 1, wherein the sealing layer 3 has embossing bridges 12′ on its outside.

11. Composite material according to claim 1, wherein the carrier material 9 has an outside layer 6 with a separating layer 8.

12. Composite material according to claim 11, wherein to form the carrier layer 2, the separating layer 8 is connected to the carrier material 9 by way of an adhesive 7.

13. Composite material according to claim 11, wherein the separating layer 8 in at least the surface region 8′ bordering the sealing layer 3 consists of non-polar substances and the sealing layer 3 on at least the surface region 3′ bordering the separating layer 8 consists of polar substances.

14. Composite material according to claim 11, wherein the separating layer 8 in at least the surface region 8′ bordering the sealing layer consists of polar substances and the sealing layer 3 on at least the surface region 3′ bordering the separating layer 8 consists of non-polar substances.

15. Composite material according to claim 1, wherein as non-polar substances, polyethylene, polypropylene, and their non-polar copolymers and non-polar derivatives are selected.

16. Composite material according to claim 1, wherein as polar substances, polyethylene terephthalate, polyamide and aluminum are selected.

17. Process for producing a composite material according to the invention according to claim 1, wherein the sealing layer 3 is applied to the carrier layer 2 by lacquering and/or lamination and/or extrusion.

18. Process for producing a composite material according to the invention according to claim 1, wherein the carrier layer 2 is formed as a precomposite consisting of the carrier material 9 and an outer layer 6, the outer layer 6 being formed from a layer of adhesive 7 and a separating layer 8 and wherein then the sealing layer 3 is applied to the outer layer 6 by lamination, lacquering or extrusion.

19. Process according to claim 17, wherein within the sealing layer 3, predetermined breaking points 4 are produced by punching in, punching through or by means of lasers.

20. Process according to claim 17, wherein the predetermined breaking points 4 are produced by sealing tools using pressure and elevated temperature, material displacement of the sealing layer taking place in the region of the predetermined breaking points.

21. (canceled)

22. (canceled)

23. (canceled)
